(19) United States
(12) Patent Application Publication
(10) Pub. No.: US 2021/0239030 A1
(43) Pub. Date: Aug. 5, 2021

(54) COOLING SYSTEM OF ENGINE

(71) Applicants: GUIZHOU GEELY ENGINE CO., LTD., Guiyang (CN); ZHEJIANG GEELY HOLDING GROUP CO., LTD, Hangzhou (CN)

(72) Inventors: Yutao XU, Guiyang, Guizhou (CN); Li HE, Guiyang, Guizhou (CN); Shujie HUANG, Guiyang, Guizhou (CN); Wei LIU, Guiyang, Guizhou (CN); Xiaobo ZHAO, Guiyang, Guizhou (CN); Qiang LI, Guiyang, Guizhou (CN); Guoqing LIU, Guiyang, Guizhou (CN); Mingyue WANG, Guiyang, Guizhou (CN); Fucheng ZHAO, Guiyang, Guizhou (CN); Ruiping WANG, Guiyang, Guizhou (CN)

(73) Assignees: GUIZHOU GEELY ENGINE CO., LTD., Guiyang (CN); ZHEJIANG GEELY HOLDING GROUP CO., LTD, Hangzhou (CN)

(21) Appl. No.: 17/270,849

(22) PCT Filed: Aug. 6, 2019
(86) PCT No.: PCT/CN2019/099325

§ 371 Date: Feb. 23, 2021

(30) Foreign Application Priority Data
Aug. 22, 2018 (CN) 201810962923.3

(51) Int. Cl. F01P 3/02; F01P 5/10; F01P 7/16; F01P 11/08

(52) U.S. Cl. CPC F01P 3/02; F01P 5/10; F01P 7/165; F01P 2007/146; F01P 2060/045; F01P 2003/024; F01P 11/08

(57) ABSTRACT

The present application provides an engine cooling system, which includes: a coolant pump; a cylinder body (22) and a cylinder cover (24), which include inside coolant passages for receiving coolant from the coolant pump, conduct heat exchange through a coolant outlet of the cylinder head (24), and send parts of the coolant back to the coolant pump; a transmission oil cooler (60) for receiving parts of the coolant from the cylinder head (24), and allowing the parts of the coolant to flow back to the coolant pump after heat exchange; the cylinder head (24) includes an upper water jacket and a lower water jacket, a temperature of the coolant output by the upper water jacket of the cylinder head is higher than a temperature of the coolant output by the lower water jacket of the cylinder head.

The patent application claims the priority of Chinese patent application number 201810962923.3, filed on Aug. 22, 2018, submitted by Guizhou Geely Engine Co., Ltd. and Zhejiang Geely Holding Group Co., Ltd., and entitled “COOLING SYSTEM OF ENGINE”. The entire disclosure of the above-identified application is incorporated herein by reference.

### TECHNICAL FIELD

The present application relates to automobile safety technology, and in particular to a cooling system of engine.

### BACKGROUND ART

With the rapid development of economy, people's travel mode has more choices, showing a diversified development trend, and the rapid development will inevitably bring environmental pressure. New policies and regulations will force a change in the automobile industry pattern. Low emissions and low fuel consumption have become the target of industry development.

### Technical Problem

As an important stage of the transition from traditional fuel vehicles to pure electric vehicles, hybrid power vehicles will become the mainstream of the market for a long time in the future. It can reduce environmental pressure while meeting people's requirements for travel. Meanwhile, the potential safety hazards brought by hybrid vehicles cannot be ignored either.

### Technical Solutions

In view of this, the present application provides a cooling system of engine.

The cooling system of engine of the present application includes: a coolant pump; a cylinder block and a cylinder head, which include inside coolant passages for receiving coolant from the coolant pump, through a coolant outlet of the cylinder head to conduct heat exchange, sending parts of the coolant back to the coolant pump; a transmission oil cooler, receiving parts of the coolant from the cylinder head, allowing the parts of the coolant to flow back to the coolant pump after heat exchange; the cylinder head is divided into upper and lower layers, including an upper water jacket of the cylinder head and a lower water jacket of the cylinder head, a temperature of the coolant output from the upper water jacket of the cylinder head is higher than a temperature of the coolant output from the lower water jacket of the cylinder head.

According to an embodiment of the present application, the cylinder head has a first cylinder head coolant outlet, and the coolant flows out the first cylinder head coolant outlet, and is partly sent back to the coolant pump after exchanging heat with a radiator; a coolant output of the radiator is further connected to a coolant input of the transmission oil cooler to deliver the cooled coolant to the transmission oil cooler.

According to an embodiment of the present application, the cylinder head has a second cylinder head coolant outlet, and the second cylinder head coolant outlet is connected to the transmission oil cooler so that the coolant output from the upper water jacket of the cylinder head is input into the transmission oil cooler; the cylinder block has a first cylinder block coolant outlet and a second cylinder block coolant outlet, the first cylinder block coolant outlet fluidly communicates the cylinder block with the cylinder head, the second cylinder block coolant outlet is in fluid communication with the coolant pump through an engine oil cooler.

According to an embodiment of the present application, the cooling system further includes a control module for controlling the on-off of fluid paths between the second cylinder head coolant outlet and the transmission oil cooler, and between the radiator and the transmission oil cooler, so that one of the upper water jacket of the cylinder head and the radiator delivers coolant to the transmission oil cooler; the control module includes: a first control valve arranged on a first fluid path L between the second cylinder head coolant outlet and the transmission oil cooler to control the on-off of the first fluid path L, so that the coolant is delivered from the second cylinder head coolant outlet to the transmission oil cooler; and a second control valve arranged on a bypass branch L between the coolant output of the radiator and the coolant input of the transmission oil cooler to control the on-off of the bypass branch L, so that the coolant is delivered from the radiator to the transmission oil cooler.

According to an embodiment of the present application, the cooling system further includes a heater core, which is also connected to the second cylinder head coolant outlet to receive the coolant sent from the upper water jacket of the cylinder head. According to an embodiment of the present application, the control module includes a third control valve, and the third control valve is arranged on a second fluid path between the second cylinder head coolant outlet and the heater core, to control the on-off of the second fluid path, so that the coolant is delivered from the second cylinder head coolant outlet to the heater core.

According to an embodiment of the present application, the cylinder head further includes a third cylinder head coolant outlet, and the third cylinder head coolant outlet is in fluid communication with the coolant pump through an EGR cooler and an EGR control valve.

According to an embodiment of the present application, a thermostat is provided between the first cylinder head coolant outlet and the radiator, for controlling the on-off of the fluid path between the first cylinder head coolant outlet and the radiator.

According to an embodiment of the present application, the first cylinder head coolant outlet is also in fluid communication with the coolant pump through a throttle valve.

According to an embodiment of the application, the cylinder head of the cylinder of the engine is non-integrated, and an exhaust manifold of the engine is not integrated into the cylinder head.

### Beneficial Effect

The cooling system of the engine of the present application can quickly reduce the temperature of the upper parts of the cylinder block and reduce the occurrence of pre-ignition and knocking. During cold start phase, the oil temperature of the transmission is quickly heated to improve transmission efficiency; and at high-speed and high-load phase, the oil temperature of the transmission can be reduced to avoid transmission failure due to excessive temperature. In addition, the water flow of warm air can be cut off when the vehicle does not need warm air, thereby reducing energy loss of the engine. The use of electric water pumps enables intelligent control of the entire water cycle of the entire cooling system, which improves the fuel economy of the vehicle.

### DESCRIPTION OF DRAWINGS

FIG. 1 is a schematic view of an cooling system of engine provided by a first embodiment of the present application.

FIG. 2 is a schematic view showing a working state of the cooling system of engine of the first embodiment of the present application, when the engine is cold started at a low temperature.

FIG. 3 is an electronic control view of the cooling system of engine of the first embodiment of the present application, when the engine is cold started at a low temperature.

FIG. 4 is a schematic view showing a working state of the cooling system of engine of the first embodiment of the present application, when the engine is in a low-speed driving phase after starting.

FIG. 5 is a schematic view showing a working state of the cooling system of engine of the first embodiment of the present application, when the engine is in a medium-speed and medium-load driving phase.

FIG. 6 is a schematic view showing a working state of the cooling system of engine of the first embodiment of the present application, when the engine is in a high-speed and high-load driving phase.

### EMBODIMENTS OF THE INVENTION

The following specific examples illustrate the implementation of the present application. Those having ordinary skill in the art can easily understand other advantages and effects of the present application from the disclosure of the specification.

In the following description, referring to the drawings, the drawings describe several embodiments of the present application. It should be understood that other embodiments can also be used, and mechanical, structural, electrical, and operational changes can also be made without departing from the spirit and scope of the present application. The following detailed description should not be considered restrictive, and the scope of the embodiments of the present application is limited only by the claims of the published patent. The terms used herein are only for describing specific embodiments, and are not intended to limit the present application. Space-related terms, such as “up”, “down”, “left”, “right”, “below”, “under”, “lower”, “above”, “upper”, etc., can be used in the disclosure to explain the relationship between one element or feature and another element or feature shown in the figures.

Although the terms first, second, etc. are used herein to describe various elements in some embodiments, these elements should not be limited by these terms. These terms are only used to distinguish one element from another element.

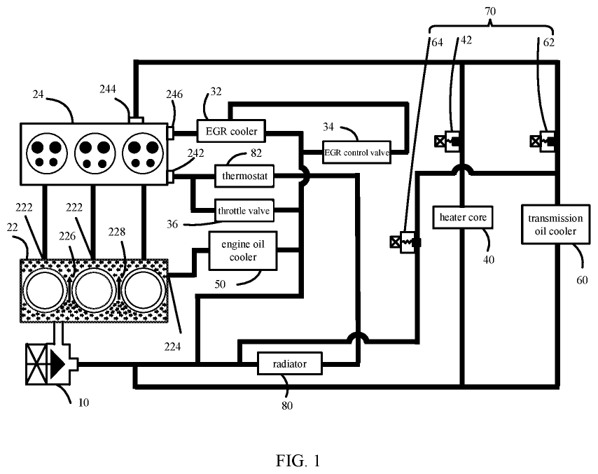

Referring to FIG. 1, the cooling system of engine of the present application includes: a coolant pump 10; a cylinder block 22 and a cylinder head 24, which are provided with inside coolant passages for receiving coolant from the coolant pump 10 and through a first cylinder head coolant outlet 242 of the cylinder head 24, a thermostat 82 and a radiator 80 sending parts of the coolant back to the coolant pump 10; a transmission oil cooler 60, for receiving parts of the coolant from the cylinder head 24 and allowing the parts of the coolant to flow back to the coolant pump 10 after heat exchange.

Specifically, the inside of the cylinder head 24 is divided into upper and lower layers, including an upper water jacket of the cylinder head and a lower water jacket of the cylinder head. A temperature of the coolant output from the upper water jacket of the cylinder head is higher than a temperature of the coolant output from the lower water jacket of the cylinder head. The upper water jacket of the cylinder head cools air passages and valves at an exhaust side, and the lower water jacket of the cylinder head cools a combustion chamber in the cylinder. In addition to the first cylinder head coolant outlet 242, the cylinder head 24 is also provided with a second cylinder head coolant outlet 244. The second cylinder head coolant outlet 244 is connected to the transmission oil cooler 60, to send the coolant from the upper water jacket of the cylinder head to the transmission oil cooler 60. For example, if the coolant in the transmission oil cooler 60 is lower than a first temperature threshold, the coolant sent from the upper water jacket of the cylinder head is input to the transmission oil cooler 60. Or, if the temperature of the coolant in the transmission oil cooler 60 is higher than the temperature of the coolant output from the second cylinder head coolant outlet 244, and the temperature of the oil in the transmission oil cooler 60 is lower than a second temperature threshold, the coolant sent from the upper water jacket of the cylinder head is input to the transmission oil cooler 60. The first temperature threshold and the second temperature threshold are both preset by the cooling system according to operating conditions of the vehicle. In addition, in this embodiment, a third cylinder head coolant outlet 246 is also provided outside the cylinder head 24, and the third cylinder head coolant outlet 246 is in fluid communication with the coolant pump 10 through an EGR (Exhaust Gas Recirculation) cooler 32, so that the EGR cooler 32 and an EGR control valve 34 can directly input the coolant from the cylinder head 24 without additional pipelines, therefore having a simple layout and a high efficiency. In another embodiment, only the first cylinder head coolant outlet 242 and the second cylinder head coolant outlet 244 are provided outside the cylinder head 24, and the EGR cooler 32 and the EGR control valve 34 inputs the coolant from the first cylinder head coolant outlet 242.

The coolant in the lower water jacket of the cylinder head cools the combustion chamber of the cylinder, and flows out through the first cylinder head coolant outlet 242 and the third cylinder head coolant outlet 246. The first cylinder head coolant outlet 242 is in fluid communication with the coolant pump 10 through a throttle valve 36 or in fluid communication with the coolant pump 10 through a thermostat 82 and the radiator 80. The third cylinder head coolant outlet 246 is in fluid communication with the coolant pump 10 through the EGR cooler 32 and the EGR control valve 34. The coolant in the upper water jacket of the cylinder head cools the air passages and valves at the exhaust side of the engine, and flows out through the second cylinder head coolant outlet 244 and the first cylinder head coolant outlet 242. The second cylinder head coolant outlet 244 is arranged at a position close to the exhaust manifold of the engine. The second cylinder head coolant outlet 244 is connected to the transmission oil cooler 60 to form a first fluid path L1, to guide a high temperature coolant from the upper water jacket of the cylinder head into the transmission oil cooler 60.

In this embodiment, the coolant inlet of the transmission oil cooler 60 is also connected with the coolant outlet of the radiator 80 to form a bypass branch L3. If the temperature of the oil in the transmission oil cooler 60 and the temperature of the coolant output from the second cylinder head coolant outlet 244 are both higher than a third temperature threshold, the coolant sent from the upper water jacket of the cylinder head is input to the transmission oil cooler 60. In this embodiment, the cooling system further includes a control module 70 for controlling the on-off of the fluid paths between the second cylinder head coolant outlet 244 and the transmission oil cooler 60, and between the radiator 80 and the transmission oil cooler 60, so that one of the upper water jacket of the cylinder head and the radiator 80 delivers coolant to the transmission oil cooler. In another embodiment, the bypass branch L3 may not be provided.

In this embodiment, the cooling system further includes a heater core 40. The second cylinder head coolant outlet 244 is also connected with the heater core 40 to form a second fluid path L2, to guide the high temperature coolant from the upper water jacket of the cylinder head into the heater core 40. If an ambient temperature is lower than a first heating core temperature threshold, the second fluid path L2 is conducted. In this embodiment, the control module 70 is also configured to be able to control the on-off of the second fluid path L2. The heater core 40 is, for example, a main component of warm air in the passenger compartment of the vehicle. In another embodiment, the cooling system does not include the heater core 40.

More specifically, in this embodiment, a first control valve 62 is also provided on the fluid path between the second cylinder head coolant outlet 244 and the transmission oil cooler 60, to control the on-off of the first fluid path L1 between the second cylinder head coolant outlet 244 and the transmission oil cooler 60. Similarly, a second control valve 64 is provided on the bypass branch L3 between the coolant inlet of the transmission oil cooler 60 and the coolant outlet of the radiator 80 to control the on-off of the bypass branch L3, so that the coolant is delivered from the outlet of the radiator 80 to the transmission oil cooler 60. A third control valve 42 is provided on the second fluid path L2 between the second cylinder head coolant outlet 244 and the heater core 40, to control the on-off of the second fluid path L2 between the cylinder head 24 and the heater core 40. The first control valve 62, the second control valve 64 and the third control valve 42 are all belong to the control module 70. In this embodiment, the first control valve 62, the second control valve 64, and the third control valve 42 are all electronically controlled flow limiting valves, which not only can intelligently control the on-off of the corresponding fluid paths, but also results a simple layout and a low cost. In other embodiments, other ways can also be used to control the on-off of the fluid path, such as using a multi-port control valve as the control module 70 to simultaneously control three fluid paths, and in some physical environments, mechanical control valves can be used to open or close the fluid path, and the control module 70 is composed of the mechanical control valves and corresponding sensors. The control module 70 pre-sets the first temperature threshold, the first heater core temperature threshold, the second temperature threshold and the third temperature threshold, according to operating conditions of the vehicle, more specifically, according to the temperature of the coolant output from the second cylinder head coolant outlet 244 and the temperature of the oil in the transmission oil cooler 60, so as to open or close the first fluid path L1, the second fluid path L2, and the third fluid path according to different temperature values.

In this embodiment, the cylinder block 22 not only include a first cylinder block coolant outlet 222 to deliver the coolant in the cylinder block 22 to the cylinder head 24, but also include a second cylinder block coolant outlet 224 to deliver the coolant in the cylinder block 22 to the engine oil cooler 50 for cooling, and the cooled coolant is delivered back to the coolant pump 10; in another embodiment, the cooling system does not include the engine oil cooler, and accordingly, the cylinder block 22 does not include the second cylinder block coolant outlet 224, either. In this embodiment, a nose bridge area of the cylinder block 22 is drilled to form nose bridge water jackets 226 and 228, which requires simple drilling process and makes the cooling efficiency of the upper portion of the water jacket be higher.

In this embodiment, the cylinder head 24 of the cylinder is of a non-integrated type, and the exhaust manifold is not integrated into the cylinder head 24, the cylinder head 24 is only designed to have two layers of water jackets, which brings stable performance and easy implementation. In other embodiments, the cylinder head 24 may also be an integrated type, and the exhaust manifold is integrated into the cylinder head 24.

In this embodiment, the coolant pump 10 is an electric water pump, which can not only reduce the mechanical load of the front gear train of the engine, but also have the advantages of precise control, simple layout and low cost. In other embodiments, the coolant pump 10 may also be a mechanical water pump.

In order to explain the working principle and system structure of the present application more clearly, the first embodiment of the present application will be explained in detail in conjunction with the working status diagram.

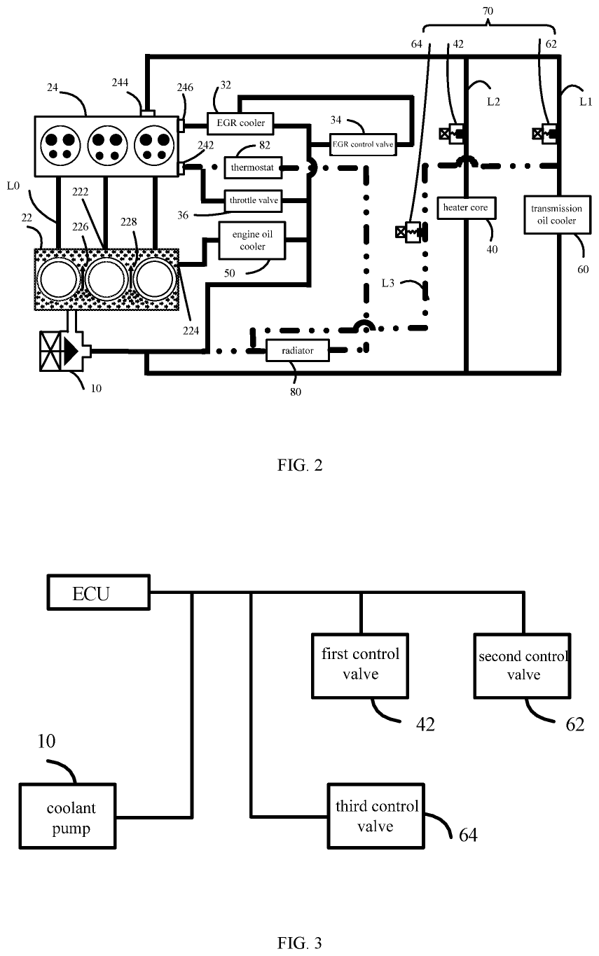

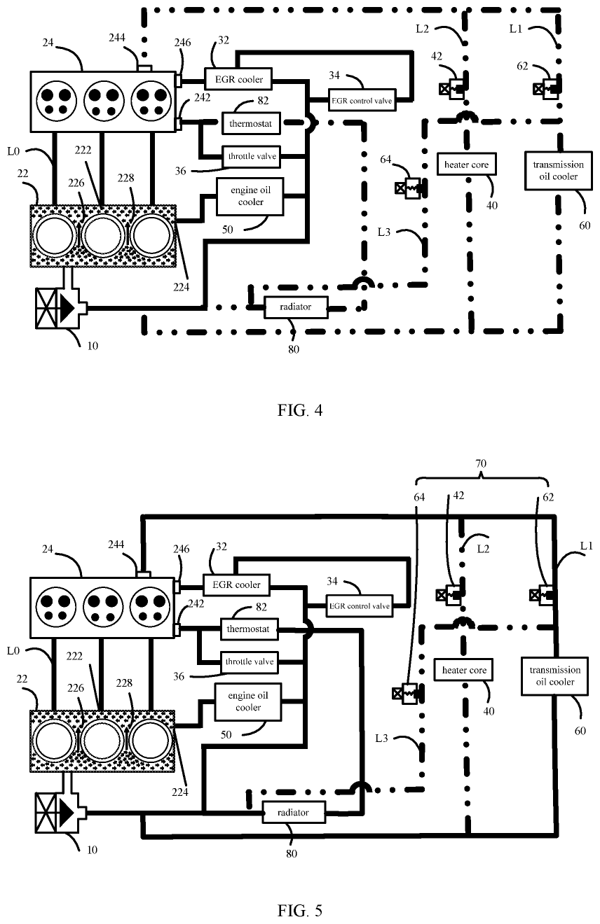

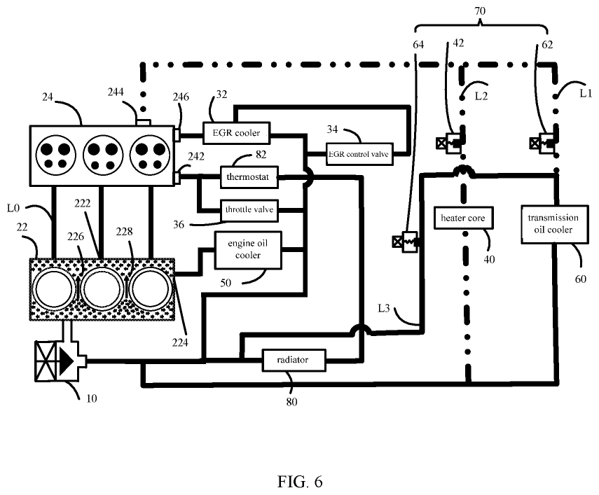

Generally speaking, the working process of the engine will go through the stages of cold start at low temperature/start at room temperature, low-speed driving after start, medium-speed and medium-load driving, and high-speed and high-load driving. The following descriptions are made accompany with FIG. 2, FIG. 3, FIG. 4, FIG. 5 and FIG. 6. FIG. 2 and FIG. 3 show the working state of cold start at low temperature, FIG. 4 shows the working state of start at room temperature/low-speed driving after start, FIG. 5 shows the working state of medium-speed and medium-load driving phase, and FIG. 6 shows the working state of high-speed and high-load driving phase. In the figures, solid lines indicate that the fluid path is on, and dashed lines indicate that the fluid path is off.

Please refer to FIG. 2, which shows the working state of a low temperature cold start phase of the first embodiment of the present application. As shown in FIG. 2, when the engine is cold-started at a low temperature or just started, the temperature of the coolant in the vehicle cooling system, the oil in the engine, and the oil in the transmission are relatively low, and the temperature of the air in the vehicle is low as well. In other words, at this time, the temperature of the coolant in the transmission oil cooler 60 is lower than the first temperature threshold, and the temperature of the heater core 40 is lower than the first heater core temperature threshold, and the ECU of the entire vehicle sends a command, and the electronic control diagram is shown in FIG. 3. The coolant pump 10 is energized and starts to work, to provide coolant for the entire cooling system. The coolant enters the cylinder block 22 through the coolant pump 10, and then enters the cylinder head 24 through an upward water path L0 of the cylinder block. Among them, parts of the coolant in the cylinder block 22 enters the nose bridge water jackets 226 and 228, and then enters the cylinder head 24 after cooling the nose bridge area. Another parts of the coolant flows through the second cylinder block coolant outlet 224 to the engine oil cooler 50, and then flows back to the coolant pump 10 through the engine oil cooler 50. The inside of the cylinder head 24 is divided into upper and lower layers, including an upper water jacket of the cylinder head and a lower water jacket of the cylinder head. The lower water jacket of the cylinder head cools the combustion chamber and flows out through the first cylinder head coolant outlet 242 and the third cylinder head coolant outlet 246. The upper layer jacket of the cylinder head cools the air passages and valves at the exhaust side, and flows out through the second cylinder head coolant outlet 244 and the first cylinder head coolant outlet 242, and the temperature of the water in the upper water jacket is higher than that in the lower water jacket.

During cold start phase, the third control valve 42 and the first control valve 62 are controlled by the ECU. As shown in FIG. 3, the ECU issues a command, the third control valve 42 and the first control valve 62 are energized and opened, and the coolant with high temperature flows directly to the heater core 40 and the transmission oil cooler 60 to quickly increase the temperature in the vehicle and improve comfort, meanwhile, the oil in the gearbox is heated, which improves the lubrication performance of the oil, reduces gearbox wear, and improves power transmission efficiency, and then the coolant flows back to the coolant pump 10. At this time, the thermostat 82 is closed, and the coolant in the lower water jacket of the cylinder head flows back to the coolant pump 10 through the EGR cooler 32, the EGR control valve 34, and the throttle valve 36, and the entire cooling cycle is completed.

When the engine starts at room temperature or enters the low-speed driving phase after start, please refer to FIG. 4, which shows the working state of the first embodiment of the present application at room temperature start phase or low-speed driving phase after start. As shown in FIG. 4, in the low-speed driving or room temperature or warm-up phase, the temperature of the engine and the temperature of the oil in the transmission are relatively high, the temperature in the vehicle is moderate, and no cooling and warm air are required. Based on the detected temperature values, the ECU determines the control target of the cooling system, and issues instructions to close the first control valve 62, the second control valve 64, and the third control valve 42, to make the first fluid path L1, the third fluid path L3 and the second fluid path L2 are all in close state. In this way, the coolant enters the cylinder block 22 and the cylinder head 24 through the coolant pump 10, and then flows out through the second cylinder block coolant outlet 224, the first cylinder head coolant outlet 242, and the third cylinder head coolant outlet 246, respectively, consistent with the flow direction of the working state shown in FIG. 2, flows back to the coolant pump 10 through the EGR cooler 32, the EGR control valve 34, the throttle valve 36 and the engine oil cooler 50, and completes the cycle.

When the engine enters the medium-speed and medium-load driving phase, the temperature of the engine and the temperature of the oil in the transmission are relatively high, and the temperature of the oil in the transmission is higher than the temperature of the coolant outlet of the engine. At this time, the large cycle of the engine needs to be turned on. In other words, at this time, the temperature of the oil in the transmission oil cooler 60 is higher than the temperature of the coolant output from the second cylinder head coolant outlet 244, and the temperature of the oil in the transmission oil cooler 60 is lower than the second temperature threshold, refer to FIG. 5, the coolant enters the cylinder block 22 through the coolant pump 10, and then enters the cylinder head 24 through the upward water path L0 of the cylinder block. Among them, parts of the coolant enter the nose bridge water jackets 226 and 228 when passing through the cylinder block 22, after cooling the nose bridge water jackets, the coolant flows to the engine oil cooler 50 through the second cylinder block coolant outlet 224 or enters the cylinder head 24 through the first cylinder block coolant outlet 222, then, the coolant water is output from the third cylinder head coolant outlet 246 and the first cylinder head coolant outlet 242, and flows back to the coolant pump 10 through the EGR cooler 32, the EGR control valve 34, the thermostat 82, the throttle valve 36, and the radiator 80. At the same time, continue to refer to FIG. 5, as shown in the first cooling path L1 in FIG. 5, the coolant cooled by the radiator 80 continues to circulate. At this time, the ECU issues a command to only energize the first control valve 62 to control the first control valve 62 to be partially opened, to cool the transmission oil by allowing the coolant passing through the transmission oil cooler 60.

When the vehicle enters the high-speed and high-load driving phase, the temperature of the coolant in the engine and the temperature of the oil in the transmission are both high, the rotation speed of the coolant pump 10 rises and rotates rapidly, the pumping volume of the coolant increases accordingly, and the cooling requirement of the engine is satisfied. However, since the coolant output from the engine cylinder head 24 no longer meets the cooling requirement of the transmission, in other words, both the temperature of the oil in the transmission oil cooler 60 and the temperature of the coolant output from the second cylinder head coolant outlet 244 are higher than the third temperature threshold, so the ECU issues a command, please refer to FIG. 6, the third control valve 42 and the first control valve 62 is closed to disconnect both of the first cooling path L1 and the second cooling path L2, and the second control valve 64 is opened. Accordingly, the coolant enters the cylinder block 22 from the coolant pump 10, and parts of the coolant in the cylinder block 22 flows to the engine oil cooler 50 through the second cylinder block coolant outlet 224, and flows back to the coolant pump 10 through the engine oil cooler 50; another parts of the coolant in the cylinder block 22 enters the cylinder head 24 from the upward water path L0 of the cylinder block, and then the coolant passes through the upper water jacket and the lower water jacket of the cylinder head 24 and flows out from the third cylinder head coolant outlet 246 and the first cylinder head coolant outlet 242, and flows back to the coolant pump 10 through the EGR cooler 32, the EGR control valve 34, the thermostat 82, the throttle valve 36 and the radiator 80 to complete a cycle. In this driving state, the thermostat 82 is turned on, the engine performs the large cycle, and parts of the coolant is output from the first cylinder head coolant outlet 242 and reaches the radiator 80 through the thermostat 82. After being cooled by the radiator 80, parts of the coolant passes through the third fluid path L3 and enters the transmission oil cooler 60 to quickly reduce the temperature of the oil in the transmission and prevent the transmission from malfunctioning due to excessive oil temperature.

It can be seen from the above description that in the cooling system of the present application, at low-temperature cold start phase, the coolant input into the heater core 40 from the cylinder head 24 is the high temperature coolant output from the second cylinder head coolant outlet 244, and therefore, the engine is warmed up faster; while the transmission oil cooler 60 can input the coolant from the first fluid path L1 through the second cylinder head coolant outlet 244 to rapidly heat up, which increases the comfort in the vehicle and the oil lubrication performance of the transmission during cold start. On the other hand, the higher-temperature coolant is quickly output from the upper water jacket of the cylinder head, which reduces the temperature of the cylinder head rapidly, and further reduces the occurrence of pre-ignition and knocking, and improves the safety of the vehicle.

For the transmission, the transmission oil cooler 60 is not only heat up rapidly by the coolant input from the first fluid path L1 through the second cylinder head coolant outlet 244, but is also quickly cooled down by the coolant input from the third fluid path L3 through the coolant outlet of the radiator 80, which brings intelligent switch and higher efficiency.

The EGR cooler 32 and the EGR control valve 34 directly enter water from the third cylinder head coolant outlet 246 of the cylinder head 24 without additional pipelines, and brings simple layout and high efficiency.

In other words, the new hybrid dedicated cooling system of engine of the present application can cool the upper parts of the cylinder block more fully, thereby reducing the occurrence of knocking; it can realize intelligent switching of the cooling water of the warm air and reduce energy consumption of the engine; in addition, it can heat or cool the transmission under all working states, which improves the transmission efficiency of the transmission and reduces the energy loss of the entire vehicle. Furthermore, it further reduces vehicle fuel consumption and emissions.

The above mentioned are only the preferred embodiments of the application, and do not limit the present application in any form. Although the present application has been disclosed in the preferred embodiments, it is not intended to limit the present application. Anyone has ordinary skill in the art, without departing from the scope of the technical solution of the present application, can use the techniques disclosed above to make slight changes or modification into equivalent embodiments with equivalent changes. As long as it does not deviate from the content of the technical solution of this application, any simple modifications, equivalent changes and modifications made to the above embodiments by the technical essence of the present application still fall within the scope of the technical solutions of the present application.

### INDUSTRIAL APPLICABILITY

The cooling system and cooling method of the engine of the present application can quickly reduce the temperature of the upper parts of the cylinder block and reduce the occurrence of pre-ignition and knocking. During cold start phase, the transmission oil temperature is quickly heated to improve transmission efficiency; while at high-speed and high-load phase, the transmission oil temperature can be reduced to avoid transmission failure due to excessive temperature. In addition, the water flow of warm air can be cut off when the vehicle does not need warm air, and the energy loss of the engine is reduced. The use of electric water pump enables the intelligent control of the entire water cycle of the entire cooling system, which improves the fuel economy of the vehicle.

1. A cooling system of engine, comprising:
a coolant pump;
a cylinder block and a cylinder head, which comprise inside coolant passages for receiving coolant from the coolant pump, through a coolant outlet of the cylinder head to conduct heat exchange, and sending parts of the coolant back to the coolant pump;
a transmission oil cooler, for receiving parts of the coolant from the cylinder head, and allowing the parts of the coolant to flow back to the coolant pump after heat exchange;
wherein the cylinder head is divided into upper and lower layers, comprising an upper water jacket of the cylinder head and a lower water jacket of the cylinder head, a temperature of the coolant output from the upper water jacket of the cylinder head is higher than a temperature of the coolant output from the lower water jacket of the cylinder head.

2. The cooling system of engine according to claim 1, wherein:
the cylinder head has a first cylinder head coolant outlet, the coolant flows out from the first cylinder head coolant outlet and is partly delivered back to the coolant pump after exchanging heat with a radiator;
a coolant output of the radiator is connected to a coolant input of the transmission oil cooler to deliver the cooled coolant to the transmission oil cooler.

3. The cooling system of engine according to claim 2, wherein:
the cylinder head has a second cylinder head coolant outlet, and the second cylinder head coolant outlet is connected to the transmission oil cooler and the coolant output from the upper water jacket of the cylinder head is input into the transmission oil cooler;
the cylinder block has a first cylinder block coolant outlet and a second cylinder block coolant outlet, and the first cylinder block coolant outlet fluidly communicates the cylinder block with the cylinder head, the second cylinder block coolant outlet is in fluid communication with the coolant pump through an engine oil cooler.

4. The cooling system of engine according to claim 3, wherein:
the cooling system further comprises a control module for controlling the on-off of fluid paths between the second cylinder head coolant outlet and the transmission oil cooler, and between the radiator and the transmission oil cooler, to make one of the upper water jacket of the cylinder head and the radiator delivers coolant to the transmission oil cooler; the control module comprises:
a first control valve arranged on a first fluid path between the second cylinder head coolant outlet and the transmission oil cooler to control the on-off of the first fluid path, enable the coolant to be delivered from the second cylinder head coolant outlet to the transmission oil cooler;
a second control valve arranged on a bypass branch between the coolant output of the radiator and the coolant input of the transmission oil cooler to control the on-off of the bypass branch, enable the coolant to be delivered from the radiator to the transmission oil cooler.

5. The cooling system of engine according to claim 3, wherein the cooling system further comprises a heater core, and the heater core is connected to the second cylinder head coolant outlet, to receive the coolant sent from the upper water jacket of the cylinder head.

6. The cooling system of engine according to claim 5, wherein the control module comprises a third control valve, and the third control valve is arranged on a second fluid path between the second cylinder head coolant outlet and the heater core, to control the on-off of the second fluid path and enable the coolant to be delivered from the second cylinder head coolant outlet to the heater core.

7. The cooling system of engine according to claim 1, wherein the cylinder head has a third cylinder head coolant outlet, and the third cylinder head coolant outlet is in fluid communication with the coolant pump through an EGR cooler and an EGR control valve.

8. The cooling system of engine according to claim 2, wherein a thermostat is provided between the first cylinder head coolant outlet and the radiator for controlling the on-off of a fluid path between the first cylinder head coolant outlet and the radiator.

9. The cooling system of engine according to claim 2, wherein the first cylinder head coolant outlet is in fluid communication with the coolant pump through a throttle valve.

10. The cooling system of engine according to claim 1, wherein the cylinder head of the cylinder of the engine is non-integrated, and an exhaust manifold of the engine is not integrated into the cylinder head.
